(19) United States
(12) Patent Application Publication
(10) Pub. No.: US 2014/0122817 A1
(43) Pub. Date: May 1, 2014

(54) SYSTEM AND METHOD FOR AN OPTIMIZED DISTRIBUTED STORAGE SYSTEM

(71) Applicant: Duke Browning, Austin, TX (US)

(72) Inventor: Duke Browning, Austin, TX (US)

(21) Appl. No.: 13/664,658

(22) Filed: Oct. 31, 2012

(51) Int. Cl. G06F 12/16

(52) U.S. Cl. 711/162; 711/E12.103

(57) ABSTRACT

In accordance with the present disclosure, a system and method for providing an optimized distributed storage system is described. The method may comprise receiving a file at a processor of a first information handling system of the distributed storage system. A copy of the file may be stored in a second information handling system of the distributed storage system. A total accessibility value for the file may be determined. The method may further include storing a copy of the file in a third information handling system of the distributed storage system if the total accessibility value is less than a first threshold. Likewise, a copy of the file may be removed from the second information handling system if the total accessibility value is greater than or equal to a second threshold.

### TECHNICAL FIELD

The present disclosure relates generally to the operation of computer systems and information handling systems, and, more particularly, to a System and Method for an Optimized Distributed Storage System.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

As the volume of information becomes larger and larger, storing that information becomes a problem. In many cases a single information handling system may not have the capacity to store the necessary data. In some cases, data may be stored to network devices, but that typically requires specialized memory devices, which can be expensive to maintain. Likewise, the capacity must be increased to accommodate additional data. Moreover, the network storage may provide an individual user a limited opportunity to control the accessibility of the data. For example, if the data is stored on a network device that is not constantly available to the network, accessing necessary data on request can become problematic or impossible.

### SUMMARY

In accordance with the present disclosure, a system and method for providing an optimized distributed storage system is described. The method may comprise receiving a file at a processor of a first information handling system of the distributed storage system. The method may also include storing a copy of the file in a second information handling system of the distributed storage system. A total accessibility value for the file may be determined. In certain embodiments, the total accessibility value for the file may be based, at least on part, on individual accessibility values of the information handling systems within the distributed storage system on which the file is stored. The method may further include storing a copy of the file in a third information handling system of the distributed storage system if the total accessibility value is less than a first threshold. In certain embodiments, the threshold may be a pre-determined minimum accessibility value for the distributed storage system. Additionally, the method may further include removing a copy of the file from the second information handling system if the total accessibility value is greater than or equal to a second threshold, which may be a pre-determined maximum accessibility value for the distributed storage system that optimizes storage space within the distributed storage system.

The present disclosure allows for certain advantages over typical distributed storage system. First, the storage of files may be optimized to ensure that the files are accessible when a user requires the files, while not requiring a large dedicated, storage device that remains coupled to the network. Rather, the number of copies of files stored, and the locale of the files within the distributed network can be optimized to ensure that the files are available. Likewise, the optimized distributed storage system allows for a user to control how and when the files are stored. Additionally, the distributed storage system may be optimized to maximize the availability of remotely stored files while limiting the total number of copies of the remotely stored files, which maximizes the available space within the distributed storage system. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows an example information handling system, according to aspects of the present disclosure.

FIG. 2 shows an example network incorporating information handling systems, according to aspects of the present disclosure.

FIG. 3 shows the layers of an example optimized distributed storage system, according to aspects of the present disclosure.

FIG. 4 shows an example method incorporating aspects of the present disclosure.

FIG. 5 shows an example method incorporating aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Illustrative embodiments of the present invention are described in detail below. In the interest of clarity, not all features of an actual implementation are described in this specification. It will of course be appreciated that in the development of any such actual embodiment, numerous implementation specific decisions must be made to achieve the developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure.

For the purposes of this disclosure, computer-readable storage media may include any instrumentality or aggregation of instrumentalities that may retain data and/or instructions for a period of time. Computer-readable storage media may include, for example without limitation, storage media such as a direct access storage device (e.g., a hard disk drive or floppy disk), a sequential access storage device (e.g., a tape disk drive), compact disk, CD-ROM, DVD, RAM, ROM, electrically erasable programmable read-only memory (EEPROM), and/or flash memory.

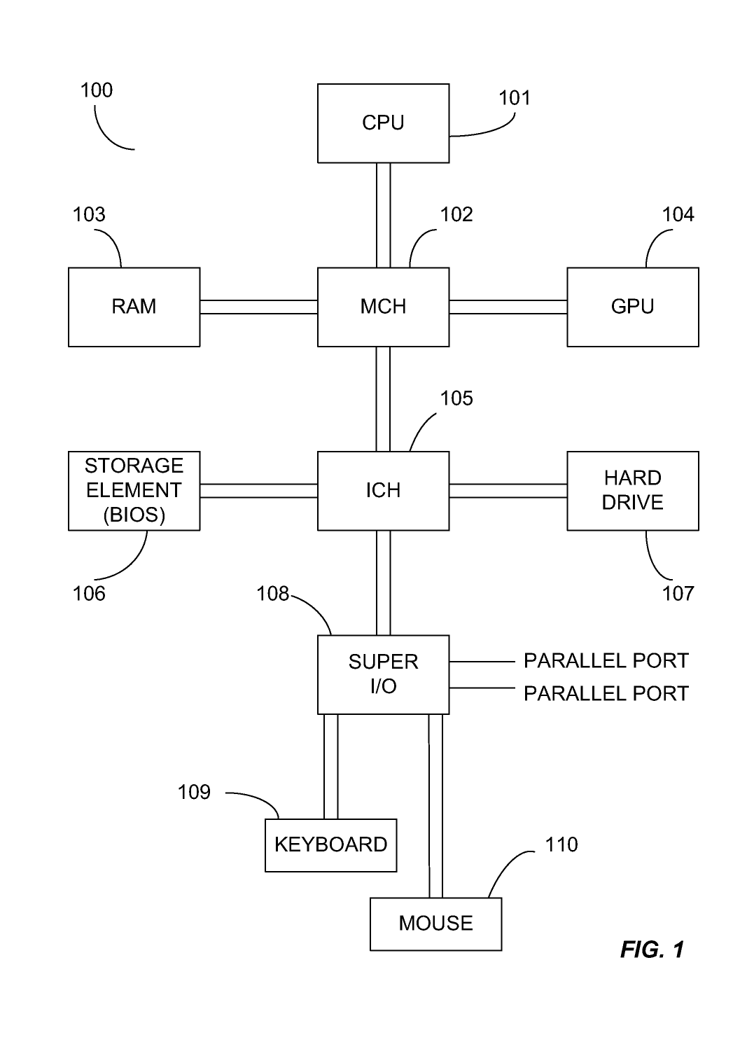

Shown in FIG. 1 is a block diagram of a typical information handling system 100. A processor or CPU 101 of the typical information handling system 100 is communicatively coupled to a memory controller hub or north bridge 102. Memory controller hub 102 may include a memory controller for directing information to or from various system memory components within the information handling system, such as RAM 103, storage element 106, and hard drive 107. The memory controller hub 102 may be coupled to RAM 103 and a graphics processing unit 104. Memory controller hub 102 may also be coupled to an I/O controller hub or south bridge 105. I/O hub 105 is coupled to storage elements of the computer system, including a storage element 106, which may comprise a flash ROM that includes the BIOS of the computer system. I/O hub 105 may be also coupled to the hard drive 107 of the computer system. I/O hub 105 may also be coupled to a Super I/O chip 108, which is itself coupled to several of the I/O ports of the computer system, including keyboard 109, mouse 110, and one or more parallel ports. The Super I/O port 108 may also comprise a network interface, through which the information handling system 100 communicates with a network, such as a local area network (LAN), wide are network (WAN), or the internet. The above description of an information handling system should not be seen to limit the applicability of the system and method described below, but is merely offered as an example computing system.

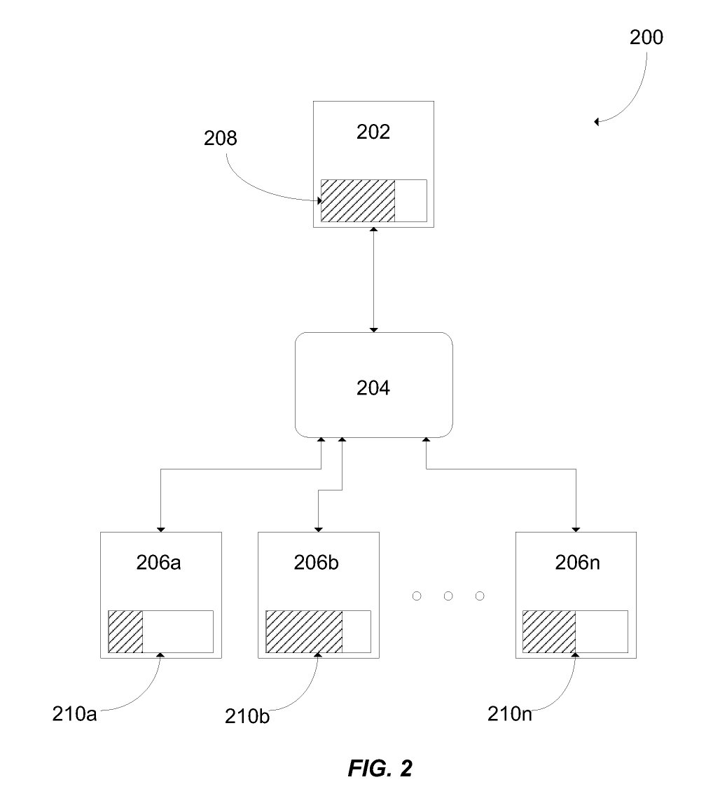

FIG. 2 shows an example network system 200. The network system 200 may incorporate information handling systems 202 and 206a-n. The information handling systems 202 and 206a-n may each comprise the structure described above with respect to FIG. 1, or some may have different configurations. For example, instead of each of the information handling systems 202 and 206a-n comprising user terminals with keyboards and monitors, some of the information handling systems may comprise dedicated storage devices, with multiple hard drives and a storage controller to manage storage operations within the storage devices. Numerous other configurations are possible, as would be appreciated by one of ordinary skill in view of this disclosure.

Each of the information handling systems 202 and 206a-n may include memory components 208 and 210a-n, respectively. The memory components may include, for example, hard drives, flash drives, etc. Each of the memory components 208 and 210a-n may store local data for each of the respective information handling systems 202 and 206a-n. This local data may include programs, files, etc. that are stored on the local memory components at the direction of a user. The local data may occupy a certain percentage of the total memory available at the memory component, as indicated by the shaded area in each of the memory components.

Each of the information handling systems 202 and 206a-n may be coupled through a network 204. The network 204 may include, for example, a LAN or another network well known in the art. In certain embodiments, as will be described below, some or all of the information handling systems 202 and 206a-n may comprise a distributed storage system. The distributed storage system may utilize the available portions of the memory/storage components 208 and 210a-n to backup files from at least one of the information handling systems 202 and 206a-n. For example, at least one copy of a local file from information handling system 202 may be stored in the available memory in at least one of memory components 210a-n.

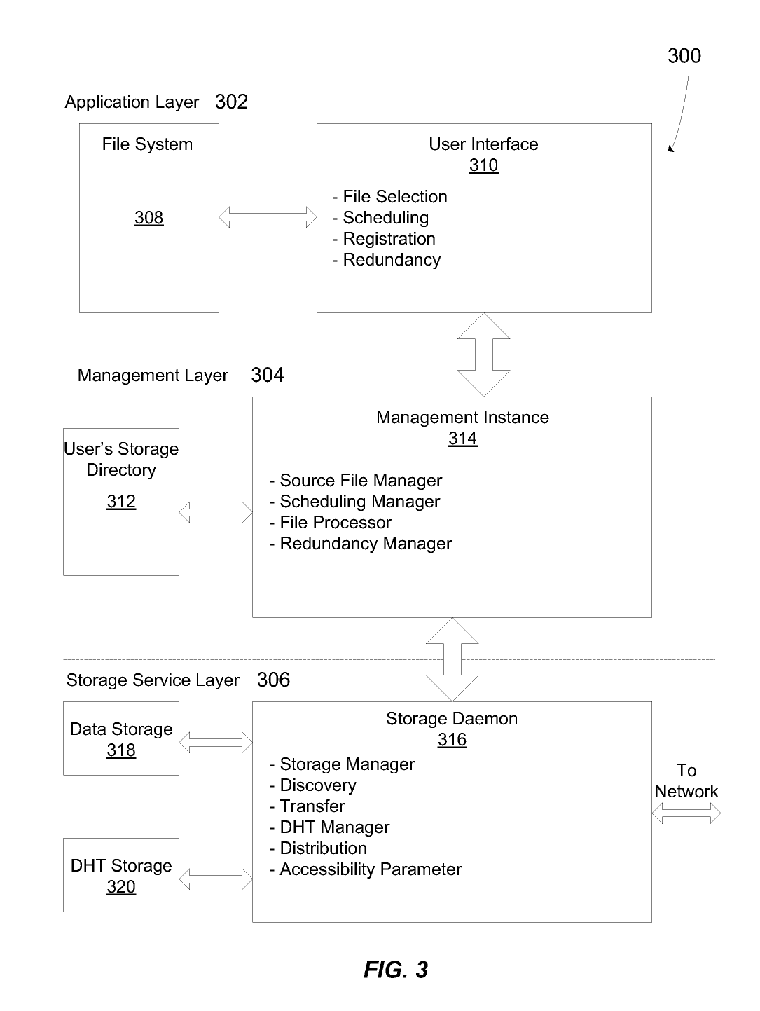

FIG. 3 shows the layers of an example optimized distributed storage system application 300, which may be implemented in an information handling system. For example, some or all of the layers may be implemented by a processor in an information handling system, according to instructions stored on a storage medium coupled to the processor, such as a hard drive, flash memory, etc. The storage medium may comprise a non-transitory, tangible storage medium. In certain embodiments, some of the layers may be implemented in the basic input/output systems (BIOS) of the information handling system, and some of the layers may be implemented as part of the operating system of the information handling system.

Application layer 302 may include a user interface 310 coupled to a file system 308. The user interface 310 may allow a user of an information handling system to access and modify the distributed storage system 300. In certain embodiments, the user interface 310 may be implemented as part of the operating system, or as a web based interface using well known programming languages, such as Java or C++. In certain embodiments, the user interface 310 may allow a user to register an information handling system with a distributed storage system, or alternatively to register a new distributed storage system. The distributed storage system may be designated, for example, as private, limiting the information handling systems which may join the distributed storage system, or public, in which case any computer in the network may join.

Once a distributed storage system is initialized or registered, a user, through the user interface 310, may select files from the file system 308 to be stored within the distributed storage system, as well as select certain operational parameters of the distributed storage system as they relate to the selected files. Those files or a file selected through the user interface 310 may be provided to the application layer 302, which may be implemented in a processor of an information handling system. The use interface 310 may access a file directory which contains a list of files saved locally on the information handling system. The application layer 302 may receive from the user choices regarding which of the locally saved files are to be stored in the distributed storage system. Additionally, the application layer 302 through the user interface 310 may receive control parameters from the user regarding the files to be stored. For example, the application layer 302 may receive a scheduling parameter from the user, which may indicate the frequency with which modified files are copied to the distributed storage system. Additionally, the application layer 302 may receive a redundancy parameter from the user, which may identify the number of copies of the selected files to be stored within the distributed storage system.

The application layer 302 may communicate with a management layer 304. In certain embodiments, the management layer 304 may comprise a management instance 314 coupled to a user's backup directory 312. The management layer 304 may be launched, for example, when a user logs in to an operating system of the information handling system. Likewise, the management instance 314 may be launched upon login. In certain embodiment, the application layer 302 may communicate with the management layer 304 using a representational state transfer (REST) application programming interface (API). The REST API may allow for the application layer 302 and management layer 304 to take a variety of configurations, using a variety of programming languages, while still allowing communication between the layers.

The application layer 302 may communicate user selections from the user interface 310 to the management instance 314. For example, the scheduling and redundancy parameters may be received at the management instance 314, as well as an identifier of the file to be stored. The management instance 314 may comprise, for example, a source file manager, a file system monitor, a scheduling manager, a file processor (for segmentation and encryption of the file in certain embodiments), and a redundancy manager. The source file manager, for example, may identify the files to be stored from the application layer 302, and create an identifier in the user's storage directory 312. The user's storage directory 312, for example, may comprise a relational database or file system segment. The scheduling manager may receive the scheduling parameter from the application layer 302, and generate commands to the storage service layer 306, which may control distribution of the file to the distributed storage system, as will be described below. Likewise, the redundancy manager may receive the redundancy parameter from the application layer 302 and generate a command to the storage service layer 306, which causes the storage service layer to store the number of copies of the selected file requested by the user, or a number of copies calculated to be necessary for reliable recovery.

In certain embodiments, the file to be stored may be divided into chunks for storage within the distributed storage system. The file processor of the management instance 314 may receive a file from the application layer 302 and divide the file into chunks. The chunks may then be passed to the storage service layer 306 for storage within the distributed storage system. In certain embodiments, the management layer 304 may communicate with the storage service layer 306 using a REST API, like between the application layer 302 and the management layer 304, but other configurations are possible, as would be appreciated by one of ordinary skill in view of this disclosure.

The storage service layer 306 may start, for example, at system boot. The storage service layer 306 may include, for example, a storage daemon 316 coupled to a data storage database 318 and a distributed hash table (DHT) storage database 320. The data storage database 318 and DHT storage data base 320 may be implemented in a self contained, embeddable database, such as SQLite, and may be used to back up files from other member information handling systems of the distributed storage system. The storage daemon 316 may include, for example a storage manager and a DHT manager. The storage manager may, for example, control the distribution and transfer of the file chunks to other information handling systems in the distributed storage system. The DHT manager, for example, may generate a DHT hash ID of the selected file and store the DHT hash ID of the file within the DHT storage database 320 or within a DHT storage database located at a different member information handling system of the distributed storage system, to track the files stored within the distributed storage system. Additionally, the storage daemon 316 may control discovery of available information handling systems within the distributed storage network.

As part of the discovery process, the storage daemon 316 may determine a separate accessibility value for an information handling system in the distributed storage system, and repeat the process for each information handling system in the distributed storage system. An accessibility value for an information handling system may be, for example, a numerical representation of the availability of the information handling systems within a distributed storage system, determined using defined accessibility criteria or parameters corresponding to the information handling system. For example, an information handling system that is generally more accessible to the distributed storage system can be given a higher or lower numerical value than a less accessible information handling system, depending on the implementation. In certain embodiments, the determination process may include retrieving a separate accessibility parameter from each of the information handling systems within the distributed storage network, and calculating the separate accessibility value for each information handling system based, at least in part, on the corresponding accessibility parameter. In certain embodiments, the storage daemon 316 may retrieve the separate accessibility values from a location in which the values have been pre-calculated and stored. In certain embodiments, an accessibility parameter for an information handling system may include, for example, machine accessibility statistics, such as the frequency with which the information handling system is connected to the network, and the duration with which the information handling system is connected to the network at the same time as a user's terminal. The separate accessibility parameter may also comprise other historical statistics, as well as the physical locale of the information handling system relative to the user's terminal.

In certain embodiments, as will be described below, the separate accessibility value for an information handling system may comprise a weight associated with the information that is calculated based, at least in part, on the corresponding accessibility parameter. The weight may be determined using one or more of the above mentioned storage parameters, and may be based solely on the corresponding accessibility parameters. In certain embodiments, the weight may account for the relative difference in accessibility parameters between the information handling systems. The storage daemon 316 may also utilize optimization thresholds when storing the files, as will be discussed below.

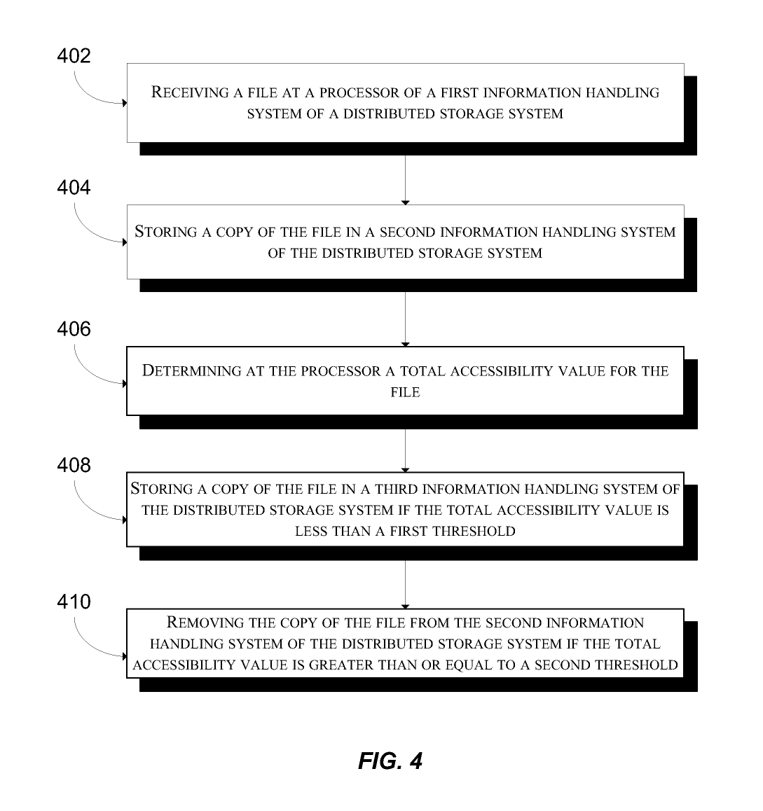

FIG. 4 illustrates an example method, incorporating aspects of the present disclosure. Step 402 comprises receiving a file at a processor of a first information handling system of a distributed storage system. The file may comprise a file selected by a user in a user interface of the first information handling system. The user interface may be implemented in an application layer, as described above, and the processor may receive the file, or an identification of the file, as part of its implementation of the application layer. In other embodiments, receiving a file may comprise receiving a file identifier as part of an update process. Step 404 may comprise storing a copy of the file in a second information handling system of the distributed network. As described above, the file may be broken up into chunks, which are stored separately within the network. Storing a copy of a file, as used it this disclosure and in the claims, may include storing all or part of a file in a storage location.

Step 406 comprises determining a total accessibility value for the file. As described above, each information handling system in the distributed storage system may be associated with its own accessibility value, which may be based, at least in part, on an accessibility parameter of the corresponding information handling system. In certain embodiments, determining a total accessibility value for the file may include adding the separate accessibility values of each information handling system of the distributed storage system in which the copy of the file is stored. The separate accessibility values and total accessibility value may comprise numerical, weighted values. For example, if the distributed storage system comprises four information handling systems IHS1, IHS2, IHS3, and IHS4; the separate accessibility values are weights assigned to each information handling system wIHS1, wIHS2, wIHS3, and wIHS4; and the file is stored in IHS1 and IHS2; then the total accessibility value for the file could equal the sum of wIHS1 and wIHS2.

Step 408 comprises storing a copy of the file in a third information handling system of the distributed storage system if the total accessibility value is less than a first threshold. In certain embodiment, the first threshold may comprise a pre-determined minimum accessibility value/threshold for the distributed storage system. As described above, the distributed storage system may be optimized to maximize the probability that a file will be available in the distributed storage system when requested. The minimum accessibility value may be set at a certain threshold value such that a file with a total accessibility value less than the threshold would not be available with the probability required in the distributed storage system. In certain embodiments, the threshold may be pre-determined for the entire distributed system based on empirical modeling, or a user may vary the threshold depending on the importance of the file. Additionally, in certain embodiments, a storage daemon, such as storage daemon 316 may identify the threshold or receive it from the management layer. The storage daemon may then compare the threshold to the total accessibility value of the file when attempting to store the file within the distributed storage system.

Step 410 comprises removing the copy of the file from the second information handling system of the distributed storage system if the total accessibility value is greater than or equal to a second threshold. In certain embodiments, the second threshold may comprise a pre-determined maximum accessibility value/threshold for the distributed storage system. As described above, the maximum accessibility value may reflect an optimization scheme that can be used to reduce the storage load on the most accessible information handling systems while still providing for the necessary file availability on request. For example, if one information handling system is nearly constantly available, it may have a higher accessibility value and therefore be frequently used to store files. Continuing the example, if a copy of a file is already stored in one information handling system but needs to be stored in another to meet the minimum accessibility value, the information handling system with the highest accessibility value may be the strongest candidate. However, if storing a copy of the file in the information handling system would increase the total accessibility value of the file above the maximum threshold, an information handling system with a lower accessibility value could be used to store the file, reducing the demand on the most reliably available information handling system.

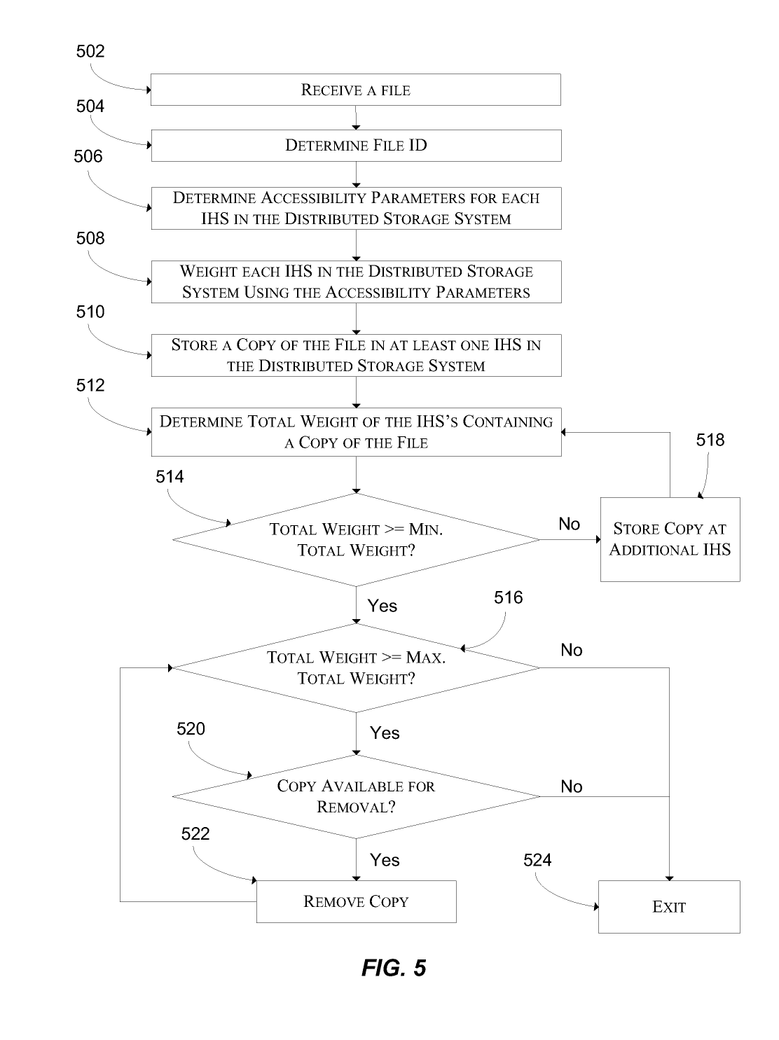

FIG. 5 illustrates an example optimized distributed storage system method. The may, for example, be implemented using a set of instructions stored on a non-transitory, tangible storage medium coupled to a processor. At step 502 a processor may receive a file. The file may be selected by a user, or selected as part of an automated update process. At step 504, the file ID for the selected file may be determined. The file ID may comprise, for example, the DHT hash ID for the file, described above. In certain embodiments, the current storage locations for the file may be identified by locating the DHT hash ID within a DHT storage database of the distributed storage system. The current storage locations may comprise each information handling system in which a chunk of the file is stored.

At step 506, the accessibility parameter for each IHS in the distributed storage system may be retrieved or determined. For example, the processor may query the information handling systems of the distributed storage system for the accessibility parameters, or may retrieve the accessibility parameters from a storage location. At step 508, a separate accessibility value may be determined for each information handling system based, at least in part, on the corresponding accessibility parameter. In FIG. 5, the accessibility value may comprise a weighted value assigned to each information handling system. A processor may determine the weights based on the accessibility parameters and using weighting algorithm, or may retrieve the weights from a storage location, where previously calculated weights are stored.

At step 510, a copy of the file may be stored in at least one information handling system of the distributed storage system. At step 512, a total weight of the information handling systems containing a copy of the file may be determined. The total weight may correspond to the total accessibility value of the file described above. At step 514, the total weight may be compared to a minimum total weight value, which may correspond to the minimum accessibility value described above. If the total weight is less than the minimum total weight threshold, a copy may be stored at an addition information handling system to increase the total weight corresponding to the file, at step 518. Conversely, in the total weight is greater than or equal to the minimum total weight threshold, the process may proceed to step 516.

At step 516, the total weight may be compared to a maximum total weight threshold, which may correspond to the maximum accessibility value described above. If the total weight is greater than or equal to the maximum total weight threshold, a copy of the file may be removed from an information handling system to reduce the total weight, at step 522. In certain embodiments, the process may query whether a copy of the file is available for removal, at step 520. A copy may be unavailable for removal, for example, if the file is required in a particular information handling system, or if there are not alternative information handling systems in which to store the copy. If the copy is not available for removal, then the process may exit at step 524. If the copy is available for removal, the copy may be removed at step 522. Once the copy is removed, the process may return back to step 516 to see if the weight has been sufficiently reduce. If it has, the process exits at step 524. If it has not, copies from additional location may be removed.

The optimized distributed storage system as described herein may be advantageous because the storage of back up files may be optimized to ensure that the files are accessible when a user requires the files, while not requiring a large dedicated, storage device that remains coupled to the network. Rather, the number of files stored, and the locale of the files within the distributed network can be optimized to ensure that the files are available. Likewise, the optimized distributed storage system allows for a user to control how and when the files are stored. Additionally, the distributed storage system may be optimized to maximize the availability of remotely stored files while limiting the total number of copies of the remotely stored files, which maximizes the available space within the distributed storage system. Although the present disclosure has been described in detail, it should be understood that various changes, substitutions, and alterations can be made hereto without departing from the spirit and the scope of the invention as defined by the appended claims.

What is claimed is:

1. A method for providing an optimized distributed storage system, comprising:
receiving a file at a processor of a first information handling system of the distributed storage system;
storing a copy of the file in a second information handling system of the distributed storage system;
determining a total accessibility value for the file; and
storing a copy of the file in a third information handling system of the distributed storage system if the total accessibility value is less than a first threshold.

2. The method of claim 1, further comprising determining a separate accessibility value for each information handling system of the distributed storage system.

3. The method of claim 2, wherein determining at the processor the total accessibility value for the file comprises adding the separate accessibility value of each information handling system of the distributed storage system in which a copy of the file is stored.

4. The method of claim 2, wherein the separate accessibility value is determined, based at least in part, on an accessibility parameter of the corresponding information handling system.

5. The method of claim 4, wherein the accessibility parameter indicates at least one of:
the duration with which the corresponding information handling system is coupled to a network, and
a location of the corresponding information handling system relative to the first information handling system.

6. The method of claim 1, further comprising removing the copy of the file from the second information handling system if the total accessibility value is greater than or equal to a second threshold.

7. The method of claim 6, wherein the first threshold comprises a pre-determined minimum accessibility value for the distributed storage system.

8. The method of claim 7, wherein the second threshold comprises a pre-determined maximum accessibility value for the distributed storage system.

9. A non-transitory, tangible storage medium containing a set of instructions, wherein the set of instructions, when executed by a processor within a first information handling system of a distributed storage system, is operable to cause the processor to:
receive a file selected by a user;
store a copy of the file in a second information handling system of the distributed storage system;
determine a total accessibility value for the file; and
store a copy of the file in a third information handling system of the distributed storage system if the total accessibility value is lower than a first threshold.

10. The non-transitory, tangible storage medium of claim 9, wherein the set of instructions is further operable to cause the processor to determine a separate accessibility value for each information handling system of the distributed storage system.

11. The non-transitory, tangible storage medium of claim 10, wherein the set of instructions is further operable to cause the processor to determine the total accessibility value for the file by adding the separate accessibility values of each information handling system of the distributed storage system in which the copy of the file is stored.

12. The non-transitory, tangible storage medium of claim 10, wherein the separate accessibility value is based, at least in part, on an accessibility parameter of the corresponding information handling system.

13. The non-transitory, tangible storage medium of claim 12, wherein the accessibility parameter indicates at least one of:
the duration with which the corresponding information handling system is coupled to a network, and
a location of the corresponding information handling system relative to the first information handling system.

14. The non-transitory, tangible storage medium of claim 9, wherein the set of instructions is further operable to cause the processor to remove the copy of the file from the second information handling system if the total accessibility value is greater than or equal to a second threshold.

15. The non-transitory, tangible storage medium of claim 14, wherein the first threshold comprises a pre-determined minimum accessibility value for the distributed storage system.

16. The non-transitory, tangible storage medium of claim 15, wherein the second threshold comprises a pre-determined maximum accessibility value for the distributed storage system.

17. An information handling system, comprising:
a processor;
a network interface coupled to the processor, wherein the information handling system is operable to communicate within a distributed storage system through the network interface; and
a memory device coupled to the processor, wherein the memory device contains a set of instructions operable to cause the processor to:
receive a file selected by a user;
store a copy of the file in a first information handling system of the distributed storage system;
determine a total accessibility value for the file;
store a copy of the file in a second information handling system of the distributed storage system if the total accessibility value is lower than a first threshold; and
remove the copy of the file from the first information handling system if the total accessibility value is greater than or equal to a second threshold.

18. The information handling system of claim 17, wherein the first information handling system is a required storage location.

19. The information handling system of claim 18, wherein the first threshold comprises a pre-determined minimum accessibility value for the distributed storage system, and the second threshold comprises a pre-determined maximum accessibility value for the distributed storage system.

20. The information handling system of claim 17, wherein the set of instructions is further operable to cause the processor to:
determine a separate accessibility value for each information handling system of the distributed storage system; and
determine the total accessibility value for the file by adding the separate accessibility values of each information handling system of the distributed storage system in which the copy of the file is stored.
